(19) United States
(12) Patent Application Publication
(10) Pub. No.: US 2009/0273272 A1
(43) Pub. Date: Nov. 5, 2009

(54) MULTI-ELECTRODE FLUORESCENT LAMP TUBE

(76) Inventor: Tianzai Huang, Guangzhou (CN)

Correspondence Address: WANG & HO, 66 HILLTOP ROAD, MILLINGTON, NJ, 07946, US

(21) Appl. No.: 11/721,812

(22) PCT Filed: Jul. 21, 2006
(86) PCT No.: PCT/CN2006/001790

§ 371 Date: Jun. 15, 2007

(30) Foreign Application Priority Data
Jul. 27, 2005 (CN) 200510036102.X

(51) Int. Cl. H01J 61/30; H01J 63/04

(52) U.S. Cl. 313/493; 313/485

(57) ABSTRACT

A fluorescent lamp with a multiple electrodes at each input, where 3 to 8 electrodes may be installed in a single electrode holder sealed at each end of the fluorescent lamp tube. In operation, electron discharge primarily only occurs from one electrode at each input end, which has smallest resistance. With multiple electrodes, the electron discharge function at each input end will last one to several times longer, compared with the input end with just a single electrode. Because the life span of the fluorescent lamp depends on the electron discharge function at each input end, multiple electrodes at each input end increases the overall service life of the lamp. This invention increases cost-effectiveness of the fluorescent lamp without requiring complex structural modifications.

### FIELD OF THE INVENTION

The present invention relates a fluorescent lamp. Particularly, the invention relates to a multi-electrode fluorescent lamp or fluorescent lamp tube.

### BACKGROUND OF THE INVENTION

The electrode used in the fluorescent lamp tube is one of key factors affecting service life of the fluorescent lamp. Ever since the fluorescent lamp was invented, in the effort to improve the performance of the electrode, research has been conducted to study various aspects of the electrode, such as its material, shape, structure, method of winding, composition of electron emission material (electron powder) and coating method, decomposition and activation process of electrode emission material during gas discharge. Progresses have continuously been made in lowering output power and increasing resistance to ionic bombardment of electron emission material on the electrode so that at the present time the life span of the fluorescent lamp can reach 8000˜12000 hours. However due to the initial “sputtering” which occurs when the lamp is switched on and the “evaporation” phenomenon during the ignition process, actual service life of the fluorescent lamp is far less than what is calculated, which reduces cost effectiveness of the fluorescent lamp.

### SUMMARY OF THE INVENTION

The object of the present invention is to provide a cost-effective fluorescent lamp with increased service life by employing multiple electrodes at each input end of the lamp tube.

The object of the invention can be realized by the following technical solution: two lead wires keeping proper balance with respect to each other in vertical direction are fixed on the stem of an electrode holder, with one lead wire being longer than the other. Welded on the long and short lead wires, are two open-ring shaped metal lead wires, respectively. The two ring shaped lead wires, sized properly according to the inner diameter of the lamp tube, are within two separate but parallel planes, with one being above the other. Between the two ring-shaped lead wires, there are welded 3 to 8 filaments, which are coated with electron powder and function as 3 to 8 electrodes on each electrode holder. Two such holders (each with 3 to 8 electrodes) are then installed, respectively, at the two ends of a fluorescent lamp tube and sealed therein.

There can also be four lead wires A, A1, B, and B1 mounted on the stem of the electrode holder. A and A1 are in electric connection with each other and B and B1 are in electric connection with each other. Two filaments are held between to wire A and wire B and two other filaments are held between wire A1 and wire B1 .These four filaments are coated with electron powder to form four electrodes on each holder. The electrode holder may be then installed and sealed at each input end of a florescent lamp tube.

In still another embodiment, three filaments may be mounted between two lead wires held in the vertical direction on an electrode holder. The filaments are coated with electron powder to form multiple electrodes on a single holder.

Furthermore, a barrel metal screen may be mounted on an independent lead wire fixed on the stem of the electrode holder. The screen encloses multiple electrodes on the holder. The screen is not in electric connection with the circuit of the lamp.

The advantages of the present invention are as follows: during the ignition process via the ballast, under the low pressure condition inside the lamp tube, the electrode with least resistant becomes the primary working electrode where the electron discharge occurs, and each of the multiple electrodes on each electrode holder takes turn to become the primary working electrode. In this way, compared with a single electrode, the functional life span of multiple electrodes is increased by one to several folds. As the service life of the fluorescent lamp depends on the functional life span of its electrodes. Multiple electrodes used at each input end increase the lamp's overall service life and thus make it more cost effective. Such multi-electrode fluorescent lamps have a simple structure and thus do not increase the manufacturing cost by much.

### BRIEF DESCRIPTION OF DRAWINGS

The details of the invention are set forth in the accompanying detailed embodiments and drawings below:

FIG. 1 is a structural schematic view showing an electrode holder having four upright electrodes.

FIG. 2 is an amplified structural schematic view showing the electrode holder of the embodiment in FIG. 1.

FIG. 3 is structural schematic view showing four electrodes fixed on four lead wires on the stem of an electrode holder.

FIG. 4 is an amplified structural schematic view showing the electrode holder of the embodiment in FIG. 3.

FIG. 5 is structural schematic view showing three electrodes fixed on two lead wires in an electrode holder.

FIG. 6 is an amplified structural schematic view showing the electrode holder of the embodiment in FIG. 5.

FIG. 7 is structural schematic view showing a multi-electrode holder using a barrel screen.

FIG. 8 is an amplified structural schematic view showing the electrode holder of the embodiment in FIG. 7.

### DETAILED DESCRIPTION OF THE INVENTION

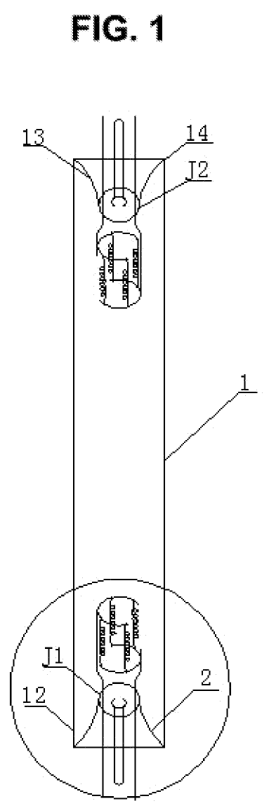

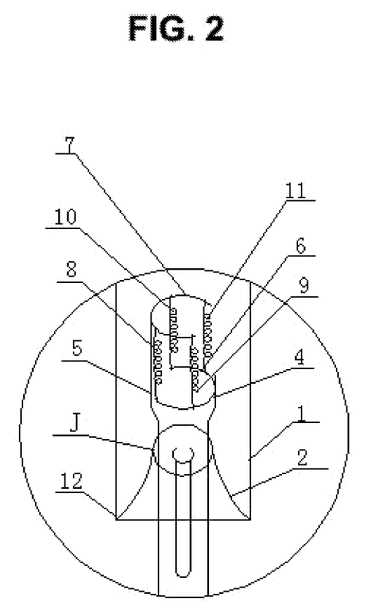

Referring to FIG. 2, in an electrode holder J, there are two lead wires 4 and 5, with lead wire 5 being longer than lead wire 4. Two circular metal wires 6 and 7, shaped like open-rings, are welded to the two lead wires 4 and 5, respectively. The circular wires 6 and 7 are within two separate but parallel planes, which are perpendicular to the two lead wires 4 and 5. The ends of wire 6 should be kept at a certain distance from the wire 4. Connected between the two circular wires 6 and 7 are four filaments 8, 9, 10, and 11, each being coated with electron powder, forming four vertically-oriented electrodes. As shown in FIG. 1, two electrode holders, J1 and J2, are respectively installed into the two input ends 12 and 14 of a florescent lamp tube 1 and each sealed at a V-shaped opening 2 or 13. In other aspects, a florescent lamp with multiple electrodes may be fabricated with conventional methods in the art.

During the start-up process of the fluoresce lamp, the active voltage punctures the gas between the electrodes, which causes glow discharge. The glow discharge then turns into arc discharge, forming thermionic arc. When local equilibrium is finally reached, it completes the normal ignition process of the fluorescent lamp. During this normal start-up process, the initial explosively rising in the temperature of the cathode causes peeling off of the emitting material coated on the electrode, significantly reducing the available amount of coating material needed for emitting electrons. When the cathodes, due to the loss of the emitting material, can no long perform sufficient termionic emission, the ignition of the fluorescence lamp will not complete but remain at the stage of glow discharge, which further causes spattering and exhaustion of the emitting material. When this happens, the lamp is dead. Therefore, a method that can increase the amount of oxide coating material on the cathodes will prolong the service life of the cathode. From experiments, it was discovered that when there are multiple electrodes at each input end of the lamp tube, under the low pressure condition inside the tube, electron discharge at each input end primarily happens from the electrode which has smallest resistance. In practice, when the ballast is switched on, the start-up process is completed mainly by relying on electron discharge happened at the electrode which is of smallest resistance at each end of the tube. Due to spattering of the oxide coating material and evaporation of the tungsten filament, both being normal events during the start-up, the resistance of the working electrode will increase. When its resistance is elevated to the point where it is no longer the least resistant among the multiple electrodes at one input end of the lamp tube, another electrode (with smallest resistance) will become the working electrode during the start-up ignition process. In this way, the electrodes will each take turn to be the working electrodes for the start-up and ignition process. The multiple electrodes installed at each end of the lamp tube will all have the chance to be the working electrode for ignition, taking turn until there is no electrode that can provide sufficient thermal electron discharge from its coating material. The service life of the lamp tube then ends. Actual practice demonstrate that, with multiple electrodes at each input end of the tube, the amount of the coating martial available for the ignition process will increase by one to several folds. The lamp tube with such multi-electrodes increases life span by one to several folds when compared with the conventional single electrode lamp tube. This technical solution, i.e., an electrode holder supporting multiple electrodes at each input end of the lamp tube, is applicable to straight tubes, circular tubes, compact tubes or complex tubes. The lamp tube can have a diameter from 12 mm to 32 mm and a power rating from 12 W to 300 W.

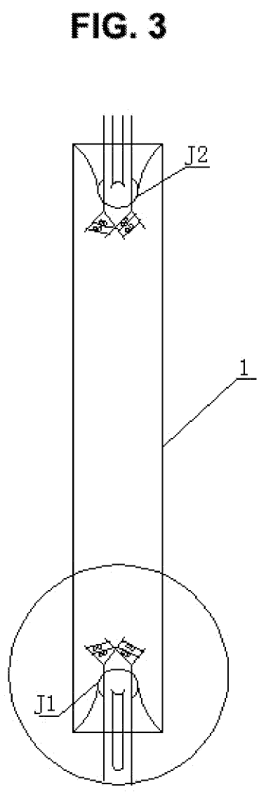

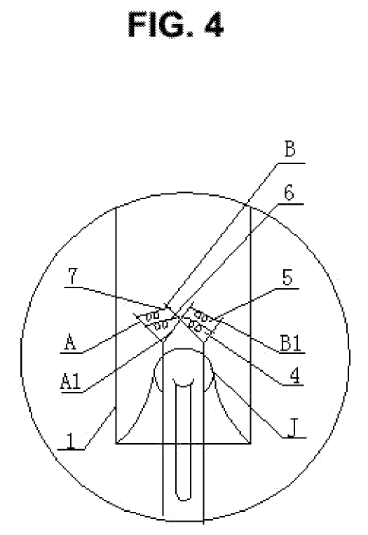

FIG. 4 is another embodiment of the present invention, the electrode holder has four lead wires A, A1, B and B1, with A being connected to A1 and B connected to B1. Filaments 6 and 7 connect between A and B and filaments 4 and 5 connect between A1 and B1. The filaments are coated with electron powder, forming four electrodes on each holder J1 and J2, which are installed at each input end of the fluoresce lamp tube and sealed at a V-shaped opening (as shown in FIG. 3). In all other aspects, a four-electrode fluoresce lamp can be manufactured with conventional methods. The lamp tube can have a diameter from 12 mm to 32 mm and a power rating from 12 W to 300 W. The operating principles are the same as the embodiment shown in FIGS. 1 and 2.

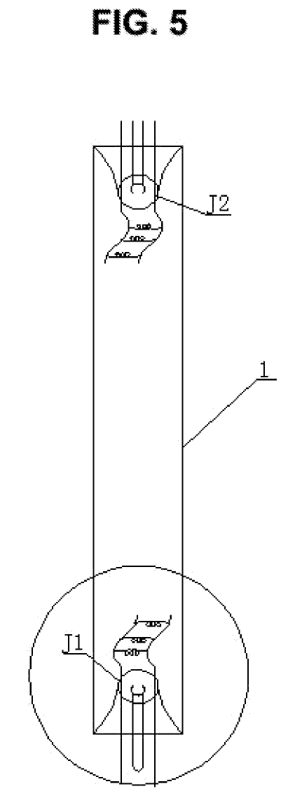

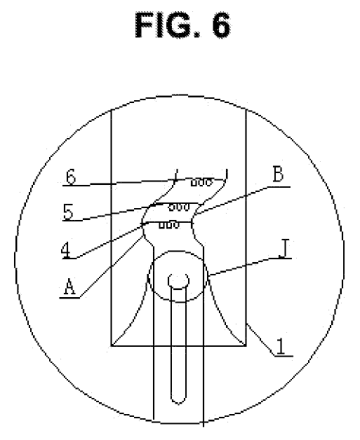

FIG. 6 shows another embodiment where three filaments 4, 5, and 6, coated with electron power, are installed on lead wires A and B, which are fixed in an electrode holder. When two electrode holders J1 and J2 are installed at each input end of the fluorescent lamp tube and sealed at V-shaped opening structures (as shown in FIG. 5), one can fabricate, with necessary methods available in the art, a three-electrode fluorescent lamp. The lamp tube can have a diameter from 9 mm to 32 mm and a power rating from 7 W to 300 W. The operating principles are the same as the embodiment shown in FIGS. 1 and 2.

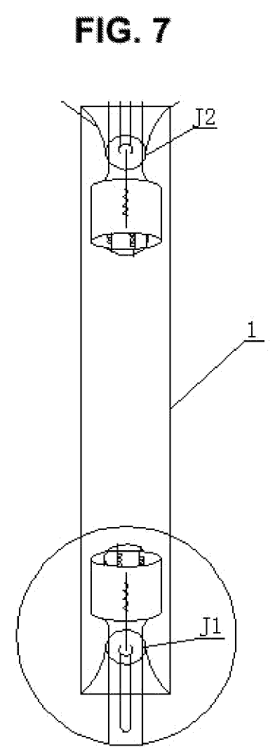

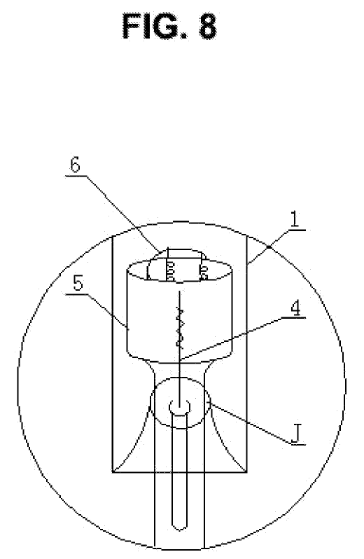

In another embodiment shown in FIG. 8, barrel shaped metal screen 5 is fixed to independent lead wire 4 mounted on the electrode holder. The barrel shaped metal screen surrounds multiple electrodes 6 installed on the electrode holder. The screen is not electrically connected to the circuit. When two electrode holders J1 and J2 are installed at each input end of the fluorescent lamp tube and sealed at V-shaped opening structures (as shown in FIG. 7), one can fabricate, with necessary methods available in the art, a fluorescent lamp with multiple electrodes surrounded by a metal screen. During the start-up ignition process and subsequent normal operation of the fluorescent lamp, the barrel metal screen can effectively avoid cross-contamination among electrodes on the same holder and evaporation of the tube wall caused by the cathode. In addition, because there is no means for anode current collection, most of the current must be received by the emission coil itself, which represents a larger portion of energy consumption required in heating the emission coil. The addition of the barrel shaped metal screen has an effect on the plasma, that is, reducing the arc cross-section area near the anode and increasing current density. It also has the effect of increasing the electron density near the cathode, reducing cathode drop and effectively improving efficiency of the fluorescent lamp.

1-4. (canceled)

5. A fluorescent lamp, comprising a tube having an input end, said input end containing multiple electrodes in parallel connection.

6. The fluorescent lamp of claim 5, wherein said electrodes are connected in a parallel relationship between a first lead wire and a second lead wire.

7. The fluorescent lamp of claim 5, wherein said electrodes are electrical filaments.

8. The fluorescent lamp of claim 7, wherein said electrical filaments are coated with electron powder.

9. The fluorescent lamp of claim 5, wherein said tube have two input ends, each containing at multiple electrodes in parallel connection.

10. The fluorescent lamp of claim 5, wherein said input end contains three to eight electrodes.

11. The fluorescent lamp of claim 6, wherein said first and second lead wires each has a open-ring like segment and said electrodes are connected between said open-ring like segment of said first lead wire and said open-ring like segment of said second lead wire.

12. The fluorescent lamp of claim 6, wherein said first and second lead wires are each forked into branches and said electrodes are connected between said branches of said first lead wire and said branches of said second lead wire.

13. The fluorescent lamp of claim 6, wherein said electrodes are enclosed within a metal screen which is not in electric connection to a circuit to which said first and second lead wire are connected.

14. The fluorescent lamp of claim 6, wherein said first and second lead wires are held in an electrode holder which seals said input end of said tube.

15. The fluorescent lamp of claim 5, wherein said tube has a diameter in a range from 9 mm to 32 mm.

16. The fluorescent lamp of claim 5, which has a power rating between 7 W to 300 W.

17. The fluorescent lamp of claim 5, wherein said tube has a diameter in a range from 12 mm to 32 mm.

18. The fluorescent lamp of claim 5, which has a power rating between 15 W to 300 W.

19. The fluorescent lamp of claim 5, where said tube is a straight tube, a circular tube, a compact tube or a tube complex.
